(19) United States
(12) Patent Application Publication
(10) Pub. No.: US 2014/0193585 A1
(43) Pub. Date: Jul. 10, 2014

(54) Method for Modifying Probe Tip

(71) Applicant: Instrument Technology Research Center, National Applied Research Laboratories, (US)

(72) Inventors: Chun-Ting Lin, Hsinchu (TW); Ming-Han Yu, Taichung City (TW); Ming-Hua Shiao, Hsinchu (TW); Mao-Nan Chang, Taichung City (TW)

(21) Appl. No.: 13/799,941

(22) Filed: Mar. 13, 2013

(30) Foreign Application Priority Data
Jan. 7, 2013 (TW) 102100478

(51) Int. Cl. B05D 3/02

(52) U.S. Cl. CPC B05D 3/0254
USPC 427/383.3; 427/383.1

(57) ABSTRACT

A method for modifying the probe tip of a microscope, including the following steps of providing a substrate, providing a metal precursor solution with fluoride ion on the substrate, using the probe tip to dip into the metal precursor solution with fluoride ion on the substrate in order to form a nano-metal particle on the probe tip by the reduction reaction of at least one metal ion in the metal precursor solution. As the result, the probe tip having the nano-metal particle thereon can increase the spatial-resolution of the measuring performance of the field sensitive scanning probe microscope due to the great reduction of stray field effects.

### CROSS-REFERENCE TO RELATED APPLICATION

This application claims the benefit of Taiwan Patent Application No. 102100478, filed on Jan. 7, 2013, in the Taiwan Intellectual Property Office, the disclosure of which is incorporated herein in its entirety by reference.

### BACKGROUND OF THE INVENTION

1. Field of the Invention

The present invention generally relates to a method for modifying the probe tip, in particular for modifying the probe tip using the metal precursor solution having fluoride ion in order to reduce the metal ion into the nano metal particle and deposit the nano metal particle on the probe tip without any additional applied voltage.

2. Description of the Related Art

As the traditional optical microscope due to the phenomenon of light waves diffraction, the resolution in theory can only reach the scale equivalent to the wavelength. Even by using X-ray, the intense radiation damage and the difficulty of the light condensing will be obtained and thereby can not reach the expected effect. Therefore, as the rapid development of the nano-technology, the measuring method based on the nano-technology has become more and more important.

In advanced material research, one of the most important issues is the measurement of two-dimensional optical, electrical, magnetic, mechanical quality of the material in the nano-scale. Although the field sensitive scanning probe microscopic (FS-SPM), such as electrostatic force microscope (EFM), magnetic force microscope (MFM) and scanning Kelvin probe microscopy (SKPM), can provide partial electric, magnetic and surface potential properties of the material. However, the aforementioned measurement would be limited due to the spatial resolution. The spatial resolution and sensitivity of the FS-SPM have a significant association with geometrical morphology and size of the probe tip.

In general, the scanning probe of the FS-SPM can be obtain from the probe using in the Atomic Force Microscopy (AFM) coated with a layer of conductive metal film on the surface thereof. Because the field sensing sectional area of the conductive metal film coated on the surface of the probe is too large to induce stray field effect, the accuracy and reliability of the scanning results would be reduced. In order to overcome the drawbacks aforementioned, numerous of probe tip modification methods have been reported. For example, U.S. Pat. No. 7,507,320 disclosed a probe modification method performed by electroplating, on said metal tip, a film of noble metal from base aqueous liquid to form a high aspect ratio of probe modification. U.S. Pat. No. 5,171,992 disclosed a probe modification method performed by ion beam assisted deposition of high aspect ratio nano-structures on the carbon substrate. EP 1744143 disclosed a probe modification method performed by using electron beam focusing on the probe tip coated with thin-film to grow nanowires thereon. However, the aforementioned dry etching and modification methods based on energy beam need to be done in a highly vacuumed environment, so the highly manufacturing cost will be needed. As the result, mass production using previous mentioned technique is hard to achieve.

Compare to the dry etching and modification method, wet etching chemical process is much easier. For example, in TW Pat. 1287089, U.S. Pat. No. 7,955,486 and U.S. Pat. No. 7,507,320, they disclose the probe modification method performed by electrochemical deposition modification. However, the aforementioned techniques need additional voltage to apply on the probe tip in order to achieve the deposition of the metal particle on the probe tip. As the result, extra power control system will be need and the manufacturing cost will be increased.

Hence, to provide an easier probe tip modification method without any additional external applied voltage in order to achieve higher spatial resolution and less manufacturing cost is very important.

### SUMMARY OF THE INVENTION

Therefore, it is a primary objective of the present invention to provide a method for modifying probe tip without any additional external applied voltage to deposit nano-metal particle on the probe tip.

To achieve the foregoing objective, the present invention provides a method for modifying probe tip comprising the steps of providing a substrate, providing a metal precursor solution having fluoride ion on the substrate, using the probe tip to dip into the metal precursor solution having fluoride ion on the substrate and reducing at least one metal ion in the metal precursor solution to form at least one nano-metal particle on the probe tip by reduction reaction.

Preferably, the substrate is a hydrophilic substrate.

Preferably, the substrate is made of anodic aluminum oxide.

Preferably, the probe tip is a silicon probe tip.

Preferably, the probe tip is not coated any metal.

Preferably, when the silicon probe tip is dipped into the metal precursor solution having fluoride ion, silicon hexafluoride ion is generated on a surface of the silicon probe tip, so as to make the silicon hexafluoride ion and the at least one metal ion of the metal precursor solution form a silicon-metal ionic bond.

Preferably, the at least one metal particle is deposited on the probe tip via self assembly effect.

Preferably, the at least one metal ion comprises silver ion (Ag⁺), copper ion (Cu²⁺), hexachloroplatinum(2−) (PtCl₆²⁻), tetrachlorogold(1−) (AuCl₄⁻), or combination thereof.

Preferably, the at least one metal particle comprises silver, copper, platinum, gold or the combination thereof.

Preferably, the size of the metal particle is ranged from 20 nm to 1000 nm.

Preferably, the size of the metal particle is ranged from 20 nm to 500 nm.

Preferably, the size of the metal particle is ranged from 20 nm to 300 nm.

Preferably, the size of the metal particle is ranged from 20 nm to 100 nm.

Preferably, the probe tip modified by the modification method of the present invention has the effectiveness of tip-enhanced Raman spectroscopy, so the resolution of single molecular could be achieved, the shorter sensing period and better sensitivity could be achieved too.

The method for modifying probe tip according to the present invention has the following advantages:

(1) The present invention provides a method for modifying probe tip without any additional external applied voltage. Therefore, the manufacturing process can be easier and the manufacturing cost can be cheaper than the prior art.

(2) The probe tip modified by the method disclosed in the present invention has nano-metal particle structure thereon. Thus, the stray field effect could be decreased effectively and the spatial resolution and sensitivity could be enhanced effectively also. Furthermore, due to the strong ionic bond between the probe tip and the nano-metal particle, the probe tip modified by the method disclosed in the present invention has better hardness than that of the prior modified by applying additional external voltage.

### BRIEF DESCRIPTION OF THE DRAWINGS

The method for modifying probe tip of the present invention will now be described in more details hereinafter with reference to the accompanying drawings.

FIG. 1 is a schematic of the probe coated the metal film of the prior art.

FIG. 2 is the first schematic of the probe modified by the modification method of the present invention.

FIG. 3 is the flow chart of the method for modifying probe tip of the present invention.

FIG. 4 is the second schematic of the probe modified by the modification method of the present invention.

FIG. 5 is the third schematic of the probe modified by the modification method of the present invention.

FIG. 6 is an SEM image of the probe modified by the modification method of the present invention.

### DETAILED DESCRIPTION OF THE PREFERRED EMBODIMENTS

The technical content of the present invention will become apparent by the detailed description of the following embodiments and the illustration of related drawings as follows.

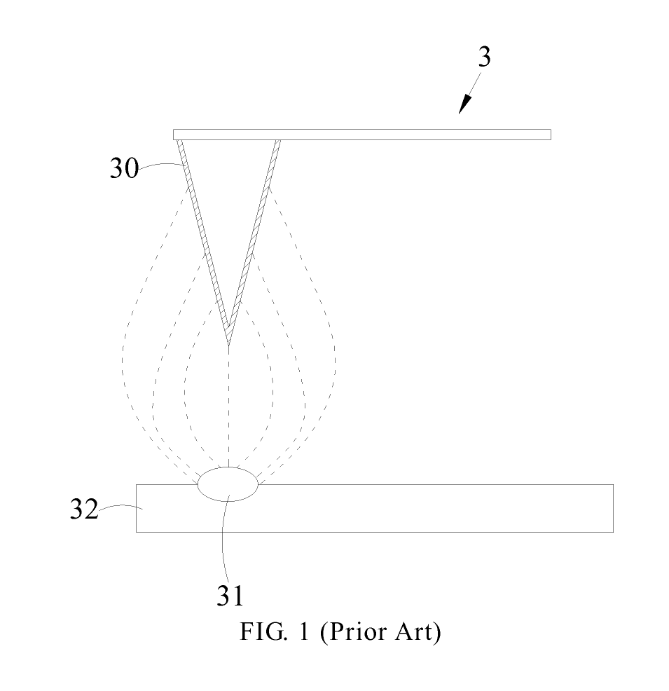

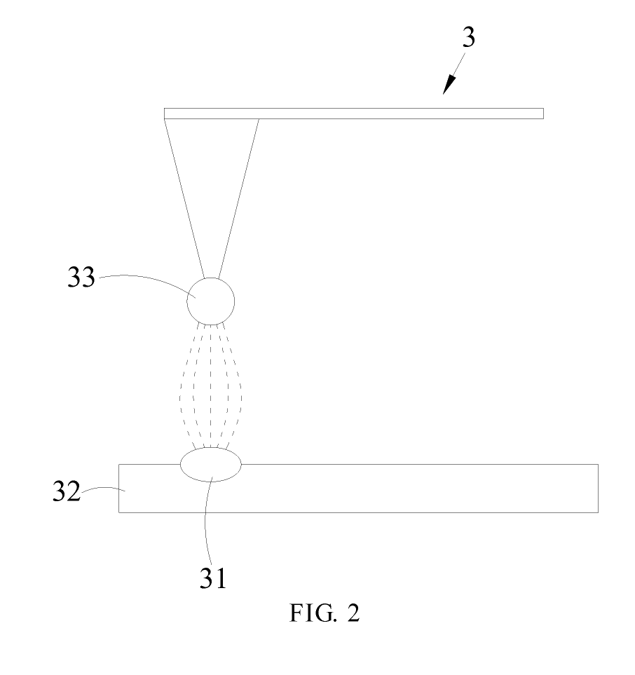

With reference to FIGS. 1 and 2. FIG. 1 is a schematic of the probe coated the metal film of the prior art. FIG. 2 is the first schematic of the probe modified by the modification method of the present invention. As shown in FIG. 1, the probe 3 of the prior has been coated a metal film 30 thereon. The distribution of the electric or magnet field can be sense or measure by the metal film 30. However, the spatial resolution and accuracy of the measuring results are extremely limited because the equivalent field sensing area of the metal film 30 is too large. As the result, depositing the metal film 30 on the probe taught by prior art can not fully meet the requirements of high accuracy in nano-scale analysis.

As shown in FIG. 2, the probe 3 modified by the method of present invention has been deposited a nano-metal particle 33 on the tip of the probe 3. The nano-metal particle 33 is used to measure the distribution of the electric or magnet field of the electronic element 31 on the substrate 32. With this structure of nano-metal particle 33, the equivalent field sensing area can be decreased so that the spatial resolution and accuracy of the measuring results can fully meet the requirements of high accuracy in nano-scale analysis.

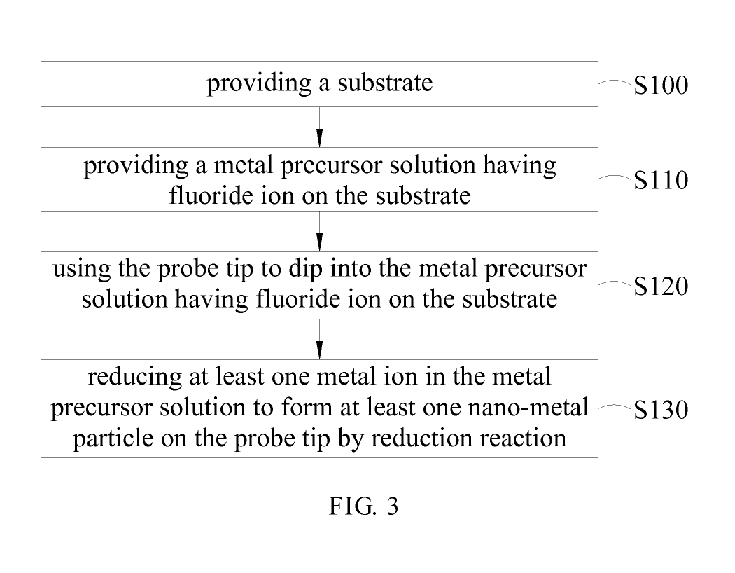

With reference to FIG. 3, it is the flow chart of the method for modifying probe tip of the present invention. The method for modifying probe tip of the present invention comprises the steps of:
S100: providing a substrate.
S110: providing a metal precursor solution having fluoride ion on the substrate.
S120: using the probe tip to dip into the metal precursor solution having fluoride ion on the substrate.
S130: reducing at least one metal ion in the metal precursor solution to form at least one nano-metal particle on the probe tip by reduction reaction.

Via the above steps, the probe tip is allowed to finish the process of the electrochemical reduction reaction. After the reduction reaction, the structure of the nano-metal particle is formed at the probe tip.

Preferably, the hydrophilic substrate can be used in the present invention. The metal precursor solution having fluoride ion is provided on the hydrophilic substrate. By using the semi-contact scanning probe microscopy probe tip to dip the metal precursor solution provided on the hydrophilic substrate, the probe tip and the metal precursor solution having fluorine ion perform localized electrochemical reduction reaction to form strong ionic bond. Then, the nano-metal particle is formed at the probe tip.

For example, the metal precursor solution can be made of 0.0625% HF solution and 0.00125M silver nitrate solution and the condition of the reaction temperature ranged from 20° C. to 25° C. and the dipping time of the probe tip ranged from 10 to 20 seconds can be determined as the modification parameters. While the hydrofluoric acid etches the SiO₂ on the surface of the probe tip, the silicon hexafluoride ion is generated at the surface of the probe tip. After that, the silver ion having 2 positive charges will be bonded with the silicon hexafluoride ion having 2 negative charges so as to form a strong silicon-metal ionic bond. At last, the silver is deposited on the probe tip via self assembly effect to form the nano-silver particle.

Besides, the at least one metal ion comprises silver ion (Ag⁺), copper ion (Cu²⁺), hexachloroplatinum(2−) (PtCl₆²⁻), tetrachlorogold(1−) (AuCl₄⁻), or the combination thereof. The at least one metal particle comprises silver, copper, platinum, gold or combination thereof. The substrate can be made of anodic aluminum oxide.

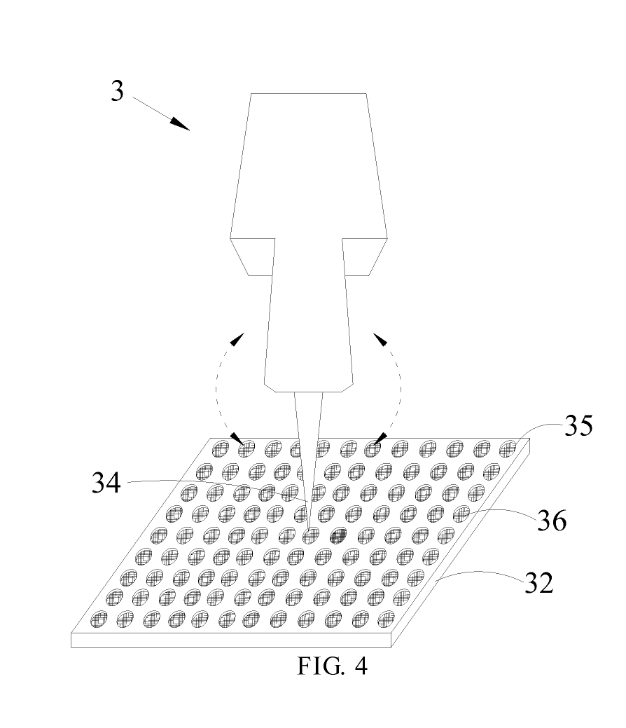

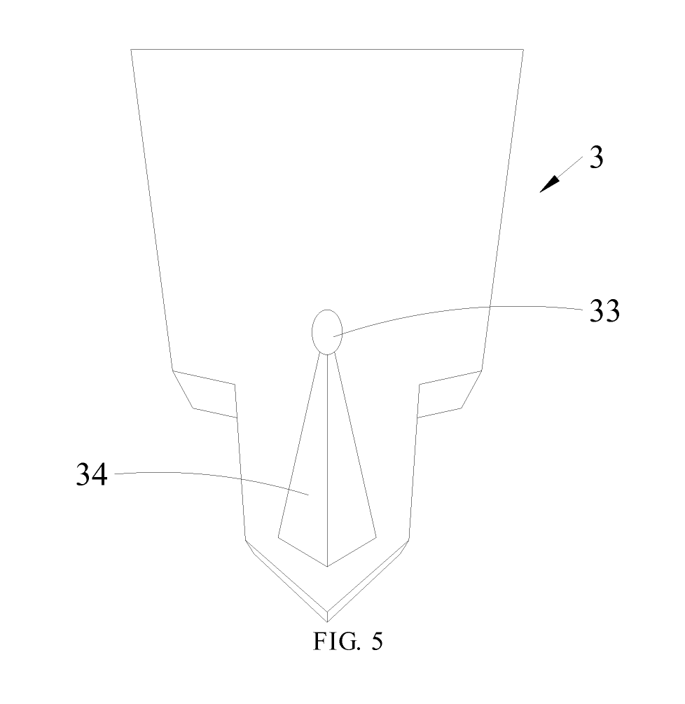

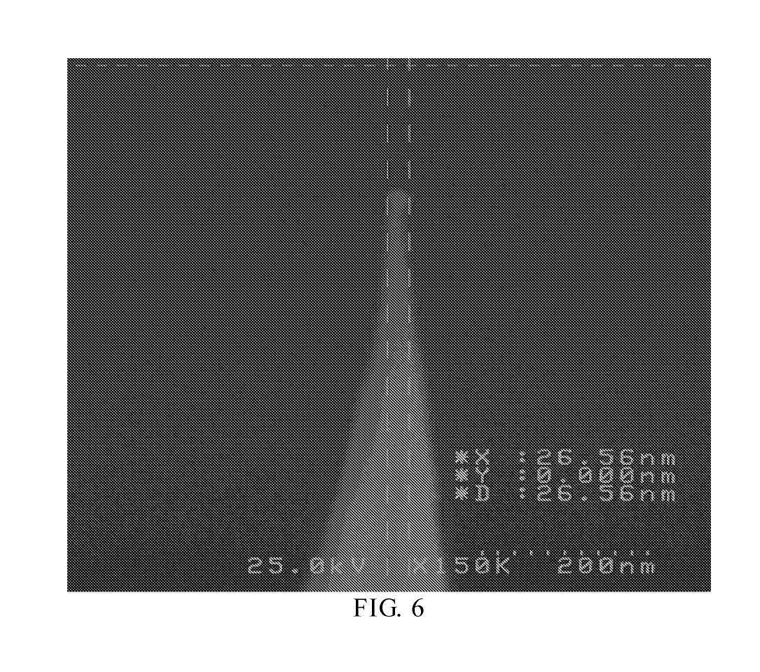

With reference to FIGS. 4 to 6. FIG. 4 is the second schematic of the probe modified by the modification method of the present invention. FIG. 5 is the third schematic of the probe modified by the modification method of the present invention. FIG. 6 is an SEM image of the probe modified by the modification method of the present invention. As shown in FIG. 4, the probe tip 34 of the probe 3 can be set over the substrate 32 and aligned with the holes 35 in the substrate 32. The probe tip 34 of the probe 3 is then dipped into the hole 35 containing the metal precursor solution 36 having fluoride ion in order to perform electrochemical reduction reaction. The metal ion in the metal precursor solution 36 will be reduced into metal particle and the metal particle is deposited on the probe tip 34 due to the self assembly effect as shown in FIG. 5. FIG. 6 is an SEM image of the probe modified by the modification method of the present invention. As the result from FIG. 6, the size of the metal particle is about 26 nm.

While the means of specifications and variations could be made thereto by those skilled in the art without departing from the scope and spirit of the invention set forth in the claims. The modifications and variations should in a range limited by the specification of the present invention.

What is claimed is:

1. A method for modifying probe tip, comprising the following steps of:
providing a substrate;
providing a metal precursor solution having fluoride ion on the substrate;
using the probe tip to dip into the metal precursor solution having fluoride ion on the substrate; and
reducing at least one metal ion in the metal precursor solution to form at least one nano-metal particle on the probe tip by reduction reaction.

2. The method for modifying probe tip of claim 1, wherein the substrate is a hydrophilic substrate.

3. The method for modifying probe tip of claim 1, wherein the substrate is made of anodic aluminum oxide.

4. The method for modifying probe tip of claim 1, wherein the probe tip is a silicon probe tip.

5. The method for modifying probe tip of claim 4, wherein when the silicon probe tip is dipped into the metal precursor solution having fluoride ion, silicon hexafluoride ion is generated on a surface of the silicon probe tip, so as to make the silicon hexafluoride ion and the at least one metal ion of the metal precursor solution form a silicon-metal ionic bond.

6. The method for modifying probe tip of claim 1, wherein the at least one metal particle is deposited on the probe tip via self assembly effect.

7. The method for modifying probe tip of claim 1, wherein the at least one metal ion comprises silver ion (Ag⁺), copper ion (Cu²⁺), hexachloroplatinum(2−) (PtCl₆²⁻), tetrachlorogold(1−) (AuCl₄⁻), or the combination thereof.

8. The method for modifying probe tip of claim 1, wherein the at least one metal particle comprises silver, copper, platinum, gold or combination thereof.

9. The method for modifying probe tip of claim 1, wherein a size of the metal particle is ranged from 20 nm to 1000 nm.
